(19) United States
(12) Patent Application Publication
(10) Pub. No.: US 2010/0076732 A1
(43) Pub. Date: Mar. 25, 2010

(54) Meshfree Algorithm for Level Set Evolution

(76) Inventors: Sangpil Yoon, Campbell, CA (US); Jiun-Der Yu, Sunnyvale, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/236,065

(22) Filed: Sep. 23, 2008

(51) Int. Cl. G06F 17/10

(52) U.S. Cl. 703/2

(57) ABSTRACT

The present invention is a system and method for simulating the motion of an interface. The interface moving through a simulation space. The invention includes simulating the interface using a level set function to describe a position and shape of the interface in the simulation space at a first point in time. The invention also includes describing the level set function at the first point time using a meshfree method. The invention further includes describing a motion of the interface from the first point in time to a second point time using a level set evolution method. The invention also includes finding an approximate solution to the level set evolution method using the meshfree method to describe the level set function at the second point in time.

### CROSS-REFERENCE TO RELATED APPLICATIONS

U.S. patent application Ser. No. 11/031,906 (Attorney Docket No. AP210HO) filed on Jan. 6, 2005, is hereby incorporated by reference in its entirety.

### BACKGROUND

1. Field of the Invention

The present invention relates generally to systems and methods for evaluating level set functions and their evolution over time. Wherein the level set function represents a physical phenomenon.

2. Description of the Related Art

The level set method is a robust method for accurately describing an arbitrarily complex interface. The level set approach defines a smooth signed distance function φ(\vec{x},t), which represents the interface as a zero level set, S=φ(\vec{x},t)=0. Instead of explicitly tracking the interface, the interface is now being “captured” by calculating the interface for which φ(\vec{x},t) is equal to zero. Generalizing to higher dimensions. The zero level set S is an n dimensional manifold in an n+1 dimensional space. The level set function φ is defined throughout the n+1 dimensional space. The absolute value of the level set function φ at any point in space is equal to the shortest distance between that point in space and the zero level set S. The sign of the level set function φ is positive on one side of the zero level set S and negative on the other side of the zero level set S.

An advantage of using the level set method over other methods is the level set method's ability to handle changes in the topology such as interface break-ups and merges. The level set method has demonstrated its ability to help the study of complex multi-fluid systems and various fluid dynamics problems such as the motion of droplets and bubbles, free surface flow, inflation of an airbag, etc. and multidimensional image processing problems such as surface processing and surface reconstruction.

The finite element (FE) method is a common method for solving a partial differential equation such as a level set evolution equation. The level set evolution equation describes changes that occur in the level set function φ over an additional dimension such as time. Finite difference methods and spectral methods may also be used to solve the level set evolution equation. The FE method solves the level set evolution equation by capturing the interface S and by interpolating finite element shape functions, much as other state variables such as pressure, velocity, or temperature are interpolated.

The interface capturing technique based on the FE method can be robust and simple to implement. However, it requires high resolution too effectively capture the evolution of the interface. The FE method involves the discretization of a given problem domain into simple geometric shapes called elements. The accuracy of the FE method depends on the size of the elements. Calculating the evolution of a level set function using the FE method with sufficient accuracy requires solving large systems of linear equations. Solving large systems of linear equations can be computationally expensive.

The present invention is aimed at reducing the computational resources required to solve level set evolution equations relative to the finite element method.

### SUMMARY OF THE INVENTION

The present invention is a system and method for simulating the motion of an interface. The interface is moving through a simulation space. The invention may include simulating the interface using a level set function to describe a position and shape of the interface in the simulation space at a first point in time. The invention may also include describing the level set function at the first point time using a meshfree method. The invention may further include describing a motion of the interface from the first point in time to a second point time, using a level set evolution method. The invention may also include finding an approximate solution to the level set evolution method using the meshfree method to describe the level set function at the second point in time.

In an embodiment of the present invention, the meshfree method may be a Reproducing Kernel Particle Method. In an embodiment of the present invention, the interface may be between a first fluid and a second fluid. In an embodiment of the present invention, the first fluid may be ink, and the second fluid may be air.

An embodiment of the present invention may be a computer-readable medium encoded with instructions for simulating the motion of an interface. An embodiment of the present invention may include a system including a memory module and instructions for simulating the motion of an interface.

In an embodiment of the present invention, the meshfree method may approximate the level set function using a first family of functions that define the smoothness of the approximation of the level set function. Each function in the first family of functions may have a compact support. The size of the compact support may be a function of a maximum of a set of k-th ordered statistics of a plurality of distances between sets of distinct nodes in the simulation space. In an embodiment of the present invention, k may be selected from the group consisting of 2, 3, 4, and 5. In an embodiment of the present invention, the size of the compact support may also be a function of an order of an enrichment function. In an embodiment of the present invention, each function in the family of function may be positive in the area bounded by the size of the compact support.

In an embodiment of the present invention, the level set evolution method may be described in terms of spatial derivates of the level set function. The spatial derivatives of the level set function may be discretized. A mesh free method may be used to describe each of the discretized terms of the spatial derivatives of the level set function.

In an embodiment of the present invention, the level set evolution method may include an integral along a boundary surrounding the simulation space. The integral may include a spatial derivate of the level set function, a test function, and components of a vector normal to the boundary.

An embodiment of the present invention may include designing a physical object based on the results of the method of simulating the motion of an interface. In an embodiment of the present invention, the physical object may be an ink jet head. An embodiment of the present invention may be the physical object that is designed based on the results of the method of simulating the motion of an interface.

An embodiment of the present may include a meshfree method that approximates the level set function using a first family of functions that define the smoothness of the approximation of the level set function. Each function in the first family of functions may have a compact support The size of the compact support may be a function of a maximum of a set of k-th ordered statistics of a plurality of power sums of differences between components that define the positions of sets of distinct nodes in the simulation space.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1A is an illustration of a FE approximation of a sine function and a derivative of the FE approximation;

FIG. 1B is an illustration of a Meshfree approximation of a sine function and a derivate of the Meshfree approximation of the sine function;

FIGS. 2A-2C show the evolution of a one-dimensional level set function over a series of time steps;

FIGS. 3A-3E are illustrations of the results of an embodiment of the present invention used to simulate the evolution of a two-dimensional level set function;

FIGS. 4A-B are illustrations of the evolution of one dimensional level set function in which the level set is not reinitialized and the boundary integral is ignored;

FIGS. 5A-B are illustrations of the evolution of one dimensional level set function in which the level set is reinitialized and the boundary integral is ignored;

FIGS. 6A-F are illustration of the evolution of a two dimensional level set function φ at several different time steps in which the level set function is reinitialized as used in an embodiment of the present invention;

FIG. 7 is an illustration of a boundary;

FIGS. 8A-B are illustrations of the evolution of one dimensional level set function in which the level set is reinitialized and the boundary integral is not ignored; and

FIG. 9 is an illustration of a system in which an embodiment of the system may be practiced.

### DESCRIPTION OF THE PREFERRED EMBODIMENTS

The present invention minimizes the computing cost required to solve a level set evolution equation. In the present invention, a Meshfree method is used to discretize a problem domain. Instead of discretizing the problem domain as in the FE method, the meshfree method scatters nodes throughout the problem domain. The Meshfree method allows a global level of approximation and eliminates the use of elements.

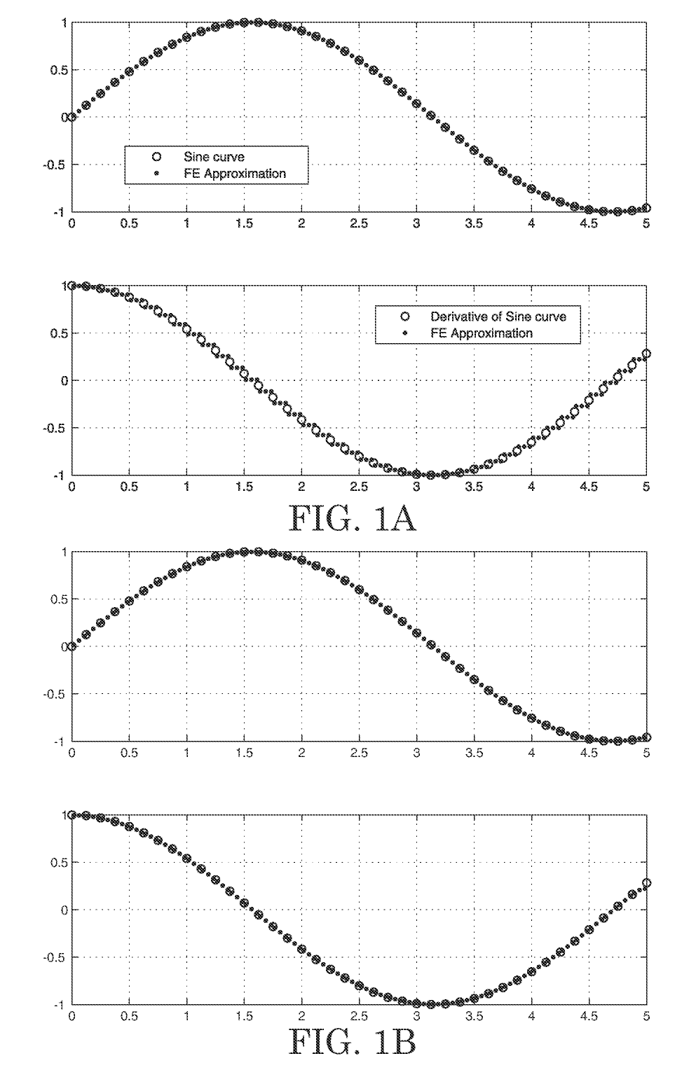

The Meshfree method has several advantages over the FE method. Among the advantages of using, the Meshfree method over the FE method is that smooth derivatives of the shape function may be obtained over the entire numerical domain. FIG. 1A is an illustration of a FE approximation of a sine function and a derivative of the FE approximation. FIG. 1B is an illustration of a Meshfree approximation of a sine function and a derivate of the Meshfree approximation. As seen in FIG. 1A the derivate of the FE method approximation includes multiple discontinuities. Whereas the derivative of the Meshfree approximation as shown in FIG. 1B is smooth.

Galerkin methods typically include the calculation of both the derivative of the shape function and the shape function itself. Thus, Galerkin methods benefit when the derivate is well behaved.

### Meshfree Method

An embodiment of the present invention makes use of a Reproducing Kernel Particle Method (RPKM) much like the method disclosed in U.S. patent application Ser. No. 11/031,906 (AP210HO) filed on Jan. 6, 2005 which is hereby incorporated by reference in it's entirety. An embodiment of the present invention may make use of RKPM with monomial basis functions.

A variable u(\vec{x}) may be approximated with a discrete reproducing kernel approximation, denoted by u^{h}, as shown in equation (1).

$${u}^{h} ( {x}^{->} ) = {\sum }_{I = 1}^{NP} {\overline{Φ}}_{a} ( {x}^{->} ; {x}^{->} - {{x}^{->}}_{I} ) {d}_{I} \qquad ( 1 )$$

In equation (1), NP is the number of discrete nodes that have been scattered throughout the simulation space. The variable d₁ represents the coefficients of the approximation. The function Φ̅ₐ(\vec{x};\vec{x}−\vec{x}ᵢ) is the reproducing kernel and is formed by a multiplication of two functions as shown in equation (2).

Φ̅(\vec{x};\vec{x}−\vec{x}_{I})=C(\vec{x};\vec{x}−\vec{x}_{I})Φₐ(\vec{x}−\vec{x}_{I}) (2)

As used in equation (2) the function Φₐ(\vec{x}−\vec{x}ᵢ) is a kernel function that defines the smoothness of the approximation and has a compact support as measured by the coefficient a. The function C(\vec{x};\vec{x}−\vec{x}ᵢ) acts as an enrichment function (i.e., a correction function). The enrichment function is used to satisfy the n-th order reproducing conditions as stated in equation (3). The variable x_{iI} is the nodal value of xᵢ at node I.

$${\sum }_{I = 1}^{NP} \overline{Φ} ( {x}^{->} ; {x}^{->} - {{x}^{->}}_{I} ) {x}_{1 I}^{p} {x}_{2 I}^{q} {x}_{3 I}^{r} = {x}_{1}^{p} {x}_{2}^{q} {x}_{3}^{q} \\ p + q + r = 0 … n ; ( {x}_{1} ≡ x , {x}_{2} ≡ y , {x}_{3} ≡ z ) \qquad ( 3 )$$

The n-th order reproducing function described in equation 3 has been defined in terms of the three dimensions: x₁; x₂; and x₃, an individual skilled in the art would appreciate how to modify equation (3) for both higher and lower dimensions. To meet the n-th order reproducing conditions of equation (3), the enrichment function C(\vec{x};\vec{x}−\vec{x}_{I}) may be constructed as a linear combination of complete n-th order monomial functions as shown in equation (4).

$$\begin{matrix}C ( {x}^{->} ; {x}^{->} - {{x}^{->}}_{I} ) = {\sum }_{p + q + r = 0}^{n} {( {x}_{1} - {x}_{1 I} )}^{p} {( {x}_{2} - {x}_{2 I} )}^{q} {( {x}_{3} - {x}_{3 I} )}^{r} {b}_{pqr} ( {x}^{->} ) \\ ≡ {H}^{T} ( {x}^{->} - {{x}^{->}}_{I} ) b ( {x}^{->} )\end{matrix} \qquad ( 4 )$$

The functions b_{pqr}(\vec{x}) are the coefficients of the monomial basis functions and are functions of the spatial vector \vec{x}, The matrix b(\vec{x}) is an m×1 matrix of the functions b_{pqr}(\vec{x}). Wherein m is the number of elements in the polynomial listed in equation (4). The matrix H(\vec{x}−\vec{x}_{I}) is an m×1 matrix containing the monomial basis functions as shown in equation (5).

H^{T}(\vec{x}−\vec{x}_{I})=[1, x₁−x_{1I}, x₂−x_{2I}, x₃−x_{3I}, (x₁−x_{1I})², . . . , (x₃−x_{3I})ⁿ] (5)

Using the notation above, n-th order reproducing conditions, equation (3) can be rewritten as equation (6).

$${\sum }_{I = 1}^{NP} H ( {x}^{->} - {{x}^{->}}_{I} ) \overline{Φ} ( {x}^{->} ; {x}^{->} - {{x}^{->}}_{I} ) = H ( 0 ) = [ 1 , 0 , … , 0 ] \qquad ( 6 )$$

The reproducing conditions of equation (6) may be written as matrix equation (7) which may be used to solve for the coefficients b(\vec{x}).

M(\vec{x})b(\vec{x})=H(0) (7)

The moment matrix M(\vec{x}) may be defined in the manner shown in equation (8).

$$M ( {x}^{->} ) = {\sum }_{I = 1}^{NP} H ( {x}^{->} - {{x}^{->}}_{I} ) {H}^{T} ( {x}^{->} - {{x}^{->}}_{I} ) {Φ}_{a} ( {x}^{->} - {{x}^{->}}_{I} ) \qquad ( 8 )$$

M(\vec{x}) is the moment matrix of the function Φₐ(\vec{x}−\vec{x}_{I}). In an embodiment of the present invention the matrix M(\vec{x}) may be required to be invertible. In order to help insure that the matrix M(\vec{x}) in equation (8) is invertible, the support a of the function φₐ(\vec{x}−\vec{x}_{I}) needs to be greater than a minimum size that is related to the order m of basis functions used in the enrichment function C(\vec{x};\vec{x}−\vec{x}_{I}) and the nodal spacing, and Φₐ(\vec{x}−\vec{x}_{I}) must be a positive function within the support.

For example, the support a may be a function of the distance between any two distinct nodes; h_{IJ}=|\vec{x}_{I}−\vec{x}_{J}|. The matrix D may be defined as complete set of these distances. A set of minimum distances between any two nodes may be defined as minimum of the matrix D across one index of the matrix

$${min}_{I} ( D ) = {min}_{I} ( \vert {\vec{x}}_{I} - {\vec{x}}_{J} \vert ) = {D}_{{( 1 )}_{I}} .$$

In an alternative embodiment of the present invention, a k-th ordered statistic of the matrix D may be used instead of the minimum wherein k is 2, 3, or 4; D₍ₖ₎_{_{I}}. The support a may be a function f of a maximum of the k-th ordered statistic of the matrix

$$D ; {max}_{J} ( {D}_{{( k )}_{I}} ) = {⌊ {D}_{{( k )}_{I}} ⌋}_{{( NP )}_{J}} ;$$

$$a = f ( {[ {D}_{{( k )}_{I}} ]}_{{( NP )}_{J}} ) , .$$

An individual skilled in the art will appreciate that all elements of the matrix D need not be calculated to obtain the information to determine the support a An individual skilled in the art will appreciate that the diagonal elements of the matrix D are zero, and need not be used in the calculation described above. In an alternative embodiment of the present invention the function f may also be a function of m the order of the basis functions, used in the enrichment function

$$C ( \vec{x} ; \vec{x} - {\vec{x}}_{I} ) ; a = f ( {[ {D}_{{( k )}_{I}} ]}_{{( NP )}_{J}} , m ) .$$

An alternative embodiment of the embodiment of the present invention may use a different method to approximate the distance between two nodes. For example it may be shown that this

$$a = f ( \sqrt{{[ {( {\sum }_{i}^{ } {( {x}_{iI} - {x}_{iJ} )}^{2} )}_{{( k )}_{I}} ]}_{{( NP )}_{J}}} , m )$$

method of calculating the support a is equivalent to the method described above. A further simplification of the calculation may include removing the square root;

$$a = f ( {[ {( {\sum }_{i}^{ } {( {x}_{iI} - {x}_{iJ} )}^{2} )}_{{( k )}_{I}} ]}_{{( NP )}_{J}} , m ) .$$

A generalization of this method may be written in terms of power sums of difference

$$a = f ( {[ {( {\sum }_{i}^{ } {( {x}_{iI} - {x}_{iJ} )}^{2 n} )}_{{( k )}_{I}} ]}_{{( NP )}_{J}} , m )$$

or

$$a = f ( {[ {( {\sum }_{i}^{ } {\vert {x}_{iI} - {x}_{iJ} \vert}^{2 n + 1} )}_{{( k )}_{I}} ]}_{{( NP )}_{J}} , m ) .$$

In this generalization, n may be any integer. For example, n may be selected from the group consisting of 1, 2, 3, 4, 5, and 6. As n gets larger greater distances have a larger effect.

Equation (1) can be rewritten as equation (9).

$${u}^{h} = {\sum }_{I = 1}^{NP} {Ψ}_{I} ( {x}^{->} ) {d}_{I} \qquad ( 9 )$$

In which the function Ψ_{I}(\vec{x}) is solved using equations (2), (4), and (7). Equation (10) is a definition of Ψ_{I}(\vec{x}) in terms of the reproducing kernel approximation.

Ψ_{I}(\vec{x})=H^{T}(0)M⁻¹(\vec{x})H(\vec{x}−\vec{x}_{I})Φₐ(\vec{x}−\vec{x}_{I}) (10)

When monomial basis functions are used in the reproducing kernel approximation, the smoothness and compact support properties of the shape function Ψ_{I}(\vec{x}) are identical to those of the kernel function Φₐ(\vec{x}−\vec{x}_{I}). Multi-dimensional kernel functions may be constructed by using the product of one-dimensional shape functions. Alternatively, the multi-dimensional kernel function may be constructing considering the distance between nodes |\vec{x}−\vec{x}_{I}| as an independent variable in the evaluation of the kernel functions.

### Level Set Formulation and Temporal Discretization

In the level set method, the free surface is identified as a zero level set, i.e. φ(\vec{x},t)=0. The free surface moves through space and time. A speed function uᵢ can be used to describe how the free surface moves. Equation (12) is a level set evolution equation that describes how the level set function φ evolves over time in terms of the speed function uᵢ.

$$\frac{\partial φ}{\partial t} + {\sum }_{i}^{ } {u}_{i} \frac{\partial φ}{\partial {x}_{i}} = 0 \qquad ( 12 )$$

An embodiment of the present invention may be directed toward a method for determining the level set function at a future time given the current state of the level set function and equation (12). Prior art methods have suffered from instabilities when standard discretization techniques are used to solve convection dominated problems such as then one described in equation (12). An embodiment of the present invention addresses this issue by making use of the Reproducing Kernel Particle Method described above in combination with an explicit Taylor Galerkin discretization. For example, the level set function φ may be expanded by using a Taylor series in time. Equation (13) is an example of this expansion in which the terms of the second order are retained.

$${φ}^{n + 1} = {φ}^{n} + Δ t \frac{\partial {φ}^{n}}{\partial t} + \frac{Δ {t}^{2}}{2} \frac{{\partial }^{2} {φ}^{n}}{\partial {t}^{2}} \qquad ( 13 )$$

From equation (12) may be rearranged as equation (14) showing the relationship between the spatial derivative of the level set function and a temporal derivative of the level set function.

$$\frac{\partial {φ}^{n}}{\partial t} = - {\sum }_{i}^{ } {u}_{i} \frac{\partial {φ}^{n}}{\partial {x}_{i}} \qquad ( 14 )$$

The second derivate of the level set function is a reasonable extension of equation (14).

$$\frac{{\partial }^{2} {φ}^{n}}{\partial {t}^{2}} = - {\sum }_{i}^{ } {u}_{i} \frac{\partial }{\partial {x}_{i}} ( \frac{\partial {φ}^{n}}{\partial t} ) = {\sum }_{i , j}^{ } {u}_{i} \frac{\partial }{\partial {x}_{i}} ( {u}_{j} \frac{\partial {φ}^{n}}{\partial {x}_{j}} ) \qquad ( 15 )$$

Using equations (14) and (15) equation (13) can be rewritten solely in terms of spatial derivates as shown in equation (16).

$${φ}^{n + 1} = {φ}^{n} - Δ t {\sum }_{i}^{ } {[ {u}_{i} \frac{\partial φ}{\partial {x}_{i}} ]}^{n} + \frac{Δ {t}^{2}}{2} {\sum }_{i , j}^{ } {[ {u}_{i} \frac{\partial }{\partial {x}_{i}} ( {u}_{j} \frac{\partial φ}{\partial {x}_{j}} ) ]}^{n} \qquad ( 16 )$$

Equation (16) may than be written in a form that is more amenable to Reproducing Kernel Particle Method as shown in equation (17)

$$\begin{matrix}Δ φ = {φ}^{n + 1} - {φ}^{n} \\ = - Δ t {\sum }_{i}^{ } {[ {u}_{i} \frac{\partial φ}{\partial {x}_{i}} ]}^{n} + \frac{Δ {t}^{2}}{2} {\sum }_{i , j}^{ } {[ {u}_{i} \frac{\partial }{\partial {x}_{i}} ( {u}_{j} \frac{\partial φ}{\partial {x}_{j}} ) ]}^{n}\end{matrix} \qquad ( 17 )$$

The level set function may than be rewritten as in equation (18) in terms of a test function Ψ.

φ=Ψ^{T}Φ (18)

Equation (18) may than be substituted into equation (17) as the which also integrated over the solution space in terms of the test function Ψ, as shown in equation (19).

$${\int }_{Ω}^{ } Ψ {Ψ}^{T} d Ω ( {Φ}^{n + 1} - {Φ}^{n} ) = \begin{matrix}- Δ t {\int }_{Ω}^{ } {\sum }_{i}^{ } Ψ {u}_{i}^{n} \frac{\partial {φ}^{n}}{\partial {x}_{i}} d Ω + \\ \frac{Δ {t}^{2}}{2} {\int }_{Ω}^{ } {\sum }_{i , j}^{ } Ψ {u}_{i}^{n} \frac{\partial }{\partial {x}_{i}} ( {u}_{j}^{n} \frac{\partial {φ}^{n}}{\partial {x}_{j}} ) d Ω\end{matrix} \qquad ( 19 )$$

An embodiment of the present invention may include reformulating equation (19) by integrating the last term of equation (19) by parts and employing the divergence theorem to produce equation (20). In which nᵢ is representative of the components of a normal vector \vec{n}(Γ) that is perpendicular to a boundary Γ which encapsulates integration space Ω.

$${\int }_{Ω}^{ } Ψ {Ψ}^{T} d Ω ( {Φ}^{n + 1} - {Φ}^{n} ) = \begin{matrix}- Δ t {\int }_{Ω}^{ } {\sum }_{i}^{ } Ψ {u}_{i}^{n} \frac{\partial {φ}^{n}}{\partial {x}_{i}} d Ω - \\ \frac{Δ {t}^{2}}{2} {\int }_{Ω}^{ } {\sum }_{i , j}^{ } \frac{\partial Ψ}{\partial {x}_{i}} {u}_{i}^{n} {u}_{j}^{n} \frac{\partial {φ}^{n}}{\partial {x}_{j}} d Ω + \\ \frac{Δ {t}^{2}}{2} {\int }_{Γ}^{ } {\sum }_{i , j}^{ } Ψ {n}_{i} {u}_{i}^{n} {u}_{j}^{n} \frac{\partial {φ}^{n}}{\partial {x}_{j}} d Γ\end{matrix} \qquad ( 20 )$$

Equation (20) may be rearranged and rewritten in matrix form as in equation (21).

MΦⁿ⁺¹=f=KΦⁿ (21)

In which the matrices are defined in equations (22)-(23). Equation (23) describes is described in terms of a two-dimensional space. An individual skilled in the art would appreciate how equation (23) could be implemented as

$$\begin{matrix}M = {\int }_{Ω}^{ } Ψ {Ψ}^{T} d Ω & ( 22 ) \\ K = {\int }_{Ω}^{ } Ψ {Ψ}^{T} d Ω - Δ t {\int }_{Ω}^{ } Ψ {B}^{T} d Ω - \frac{Δ {t}^{2}}{2} {\int }_{Ω}^{ } {BB}^{T} d Ω + \frac{Δ {t}^{2}}{2} {\int }_{Γ}^{ } Ψ ( {n}_{1} {u}_{1}^{n} + {n}_{2} {u}_{2}^{n} ) {B}^{T} d Γ & ( 23 )\end{matrix}$$

The following integrals in equations (24)-(26) can be used to describe the matrix B in terms of integral equations

$$\begin{matrix}{\int }_{Ω}^{ } Ψ ( {u}_{1}^{n} \frac{\partial {φ}^{n}}{\partial {x}_{1}} + {u}_{2}^{n} \frac{\partial {φ}^{n}}{\partial {x}_{2}} ) d Ω = {\int }_{Ω}^{ } Ψ {B}^{T} d Ω {Φ}^{n} & ( 24 ) \\ {\int }_{Γ}^{ } Ψ ( {n}_{1} {u}_{1}^{n} + {n}_{2} {u}_{2}^{n} ) ( {u}_{1}^{n} \frac{\partial {φ}^{n}}{\partial {x}_{1}} + {u}_{2}^{n} \frac{\partial {φ}^{n}}{\partial {x}_{2}} ) d Γ = {\int }_{Γ}^{ } Ψ ( {n}_{1} {u}_{1}^{n} + {n}_{2} {u}_{2}^{n} ) {B}^{T} d Γ {Φ}^{n} & ( 25 ) \\ {\int }_{Ω}^{ } ( {u}_{1}^{n} \frac{\partial Ψ}{\partial {x}_{1}} + {u}_{2}^{n} \frac{\partial Ψ}{\partial {x}_{2}} ) ( {u}_{1}^{n} \frac{\partial {φ}^{n}}{\partial {x}_{1}} + {u}_{2}^{n} \frac{\partial {φ}^{n}}{\partial {x}_{2}} ) d Ω = {\int }_{Ω}^{ } {BB}^{T} d Ω {Φ}^{n} \\ B = {\sum }_{i}^{ } {u}_{i}^{n} \frac{\partial Ψ}{\partial {x}_{i}} & ( 26 )\end{matrix}$$

### Reinitializing the Level Set Function

An embodiment of the present invention uses the meshfree method to simulate the motion of the level set function by using the level set evolution equation. The new level set function produced by the present invention m no longer be a signed distance function such that |∇φ|≠1. One method of addressing this issue is to re-initialize the level set function frequently such that, |∇φ|=1. Conventional routines for reinitializing a distance function enforce φ=0 at the interface and reset φ at all points close to the interface, which requires finding the interface and significantly increases the resources required to simulate many systems. One method for solving this problem is to integrate a reinitialization equation such as the one shown in equation (27).

φ_{τ}+s(φ₀)|∇φ−1|=0 (27)

Equation (27) may be integrated for a short period of artificial time τ, where φ shares the same zero level set with the current level set function φ₀, τ is an artificial time period, s(φ₀) is the smoothed sign function and φ₀ is the current level set to be reinitialized. The current level set function φ₀ may be far from the signed distance function.

The reinitialization of the level set function may be achieved by solving the following partial differential equation (27). Until a steady state form of the level set function φ is reached everywhere or at points near the interface. Equation (27) may be written in a steady state form as in equation (28). The terms used in equation (28) may be found in equations (29) and equation (30).

$$\begin{matrix}\frac{\partial φ}{\partial τ} + {c}^{->} \cdot ∇ φ = \frac{\partial φ}{\partial τ} + {\sum }_{i}^{ } {c}_{i} \frac{\partial φ}{\partial {x}_{i}} = s ( {φ}_{0} ) & ( 28 ) \\ {c}^{->} = s ( {φ}_{0} ) \frac{∇ φ}{\vert ∇ φ \vert} , s ( {φ}_{0} ) = {s}_{0} = \frac{{φ}_{0}}{\sqrt{{φ}_{0}^{2} + {( \vert ∇ {φ}_{0} \vert ɛ )}^{2}}} & ( 29 ) \\ {φ}_{0} ( {x}^{->} , τ = 0 ) = φ ( {x}^{->} , t ) & ( 30 )\end{matrix}$$

Equation (28) may be rewritten as equation (31).

$$\frac{\partial φ}{\partial τ} = s ( {φ}_{0} ) - {\sum }_{i}^{ } {c}_{i} \frac{\partial φ}{\partial {x}_{i}} \qquad ( 31 )$$

Equation (32) shows how the second temporal derivative of the level set function φ may be written using equation (31).

$$\begin{matrix}\frac{{\partial }^{2} φ}{\partial {τ}^{2}} = \frac{\partial }{\partial τ} ( s ( {φ}_{0} ) - {\sum }_{i}^{ } {c}_{i} \frac{\partial φ}{\partial {x}_{i}} ) \\ = - {\sum }_{i}^{ } {c}_{i} \frac{\partial }{\partial τ} ( \frac{\partial φ}{\partial {x}_{i}} ) \\ = - {\sum }_{i}^{ } {c}_{i} \frac{\partial }{\partial {x}_{i}} ( \frac{\partial φ}{\partial τ} ) \\ = - {\sum }_{i}^{ } {c}_{i} \frac{\partial }{\partial {x}_{i}} ( s ( {φ}_{0} ) - {\sum }_{j}^{ } {c}_{j} \frac{\partial φ}{\partial {x}_{j}} ) \\ = {\sum }_{i , j}^{ } {c}_{i} \frac{\partial }{\partial {x}_{i}} ( {c}_{j} \frac{\partial φ}{\partial {x}_{j}} )\end{matrix} \qquad ( 32 )$$

Equations (31) and (32) may be substituted into equation (13) to form equation (33). Equation (33) describes the temporal evolution of the level set function from a first point in time to a second point in time in terms of spatial derivative of the level set function at a first point in time.

$$\begin{matrix}{φ}^{n + 1} - {φ}^{n} = Δ τ \frac{\partial {φ}^{n}}{\partial τ} + \frac{Δ {τ}^{2}}{2} \frac{\partial {φ}^{{n}^{2}}}{\partial {τ}^{2}} \\ = {\sum }_{i , j}^{ } Δ τ ( {s}_{0} - {c}_{i}^{n} \frac{\partial {φ}^{n}}{\partial {x}_{i}} ) + \frac{Δ {τ}^{2}}{2} {c}_{i}^{n} \frac{\partial }{\partial {x}_{i}} ( {c}_{j}^{n} \frac{\partial {φ}^{n}}{\partial {x}_{j}} )\end{matrix} \qquad ( 33 )$$

The relations in equations (34) may be derived from equation (29).

$${\sum }_{i}^{ } {c}_{i} \frac{\partial φ}{\partial {x}_{i}} = {s}_{0} \frac{∇ φ}{\vert ∇ φ \vert} \cdot ∇ φ = {s}_{0} \vert ∇ φ \vert \\ and \\ {\sum }_{i}^{ } {c}_{i} {s}_{0} \vert ∇ φ \vert = {s}_{0} \frac{∇ φ}{\vert ∇ φ \vert} {s}_{0} \vert ∇ φ \vert = ∇ φ \qquad ( 34 )$$

Substituting the relations from Equation (34) into equation (33) gives us equation (35)

$$\begin{matrix}{φ}^{n + 1} - {φ}^{n} = {\sum }_{i , j}^{ } Δ τ ( {s}_{0} - {c}_{i}^{n} \frac{\partial {φ}^{n}}{\partial {x}_{i}} ) + \frac{Δ {τ}^{2}}{2} {c}_{i}^{n} \frac{\partial }{\partial {x}_{i}} ( {c}_{j}^{n} \frac{\partial {φ}^{n}}{\partial {x}_{j}} ) \\ = {\sum }_{i}^{ } Δ τ ( {s}_{0} - {s}_{0} \vert ∇ {φ}^{n} \vert ) + \frac{Δ {τ}^{2}}{2} {c}_{i}^{n} \frac{\partial }{\partial {x}_{i}} ( {s}_{0} \vert ∇ {φ}^{n} \vert ) \\ = {\sum }_{i}^{ } Δ τ ( {s}_{0} - {s}_{0} \vert ∇ {φ}^{n} \vert ) + \frac{Δ {τ}^{2}}{2} \{ \begin{matrix}\frac{\partial }{\partial {x}_{i}} ( {c}_{i}^{n} {s}_{0} \vert ∇ {φ}^{n} \vert ) - \\ {s}_{0} \frac{\partial {c}_{i}^{n}}{\partial {x}_{i}} \vert ∇ {φ}^{n} \vert\end{matrix} \} \\ = {\sum }_{i}^{ } Δ τ ( {s}_{0} - {s}_{0} \vert ∇ {φ}^{n} \vert ) + \frac{Δ {τ}^{2}}{2} \{ \frac{\partial ∇ {φ}^{n}}{\partial {x}_{i}} - {s}_{0} \frac{\partial {c}_{i}^{n}}{\partial {x}_{i}} \vert ∇ {φ}^{n} \vert \} \\ = {\sum }_{i}^{ } Δ τ ( {s}_{0} - {s}_{0} \vert ∇ {φ}^{n} \vert ) - \frac{Δ {τ}^{2}}{2} {s}_{0} \frac{\partial {c}_{i}^{n}}{\partial {x}_{i}} \vert ∇ {φ}^{n} \vert + \\ \frac{Δ {τ}^{2}}{2} \frac{\partial ∇ {φ}^{n}}{\partial {x}_{i}}\end{matrix} \qquad ( 35 )$$

As before the level set function may be rewritten as in equation (18) in terms of a test function Ψ. Equation (18) may than be substituted into equation (35) and integrated over the solution space in terms of the test function Ψ, as shown in equation (36).

$${\int }_{Ω}^{ } Ψ {Ψ}^{T} d Ω ( {Φ}^{n + 1} - {Φ}^{n} ) = Δ τ {\int }_{Ω}^{ } Ψ {s}_{0} ( 1 - \vert ∇ {φ}^{n} \vert ) d Ω - \frac{Δ {τ}^{2}}{2} {\int }_{Ω}^{ } Ψ {s}_{0} \frac{\partial {c}_{i}^{n}}{\partial {x}_{i}} \vert ∇ {φ}^{n} \vert d Ω - \frac{Δ {τ}^{2}}{2} {\int }_{Ω}^{ } \frac{\partial Ψ}{\partial {x}_{i}} \frac{\partial {φ}^{n}}{\partial {x}_{i}} d Ω + \frac{Δ {τ}^{2}}{2} {\int }_{Γ}^{ } Ψ \frac{\partial {φ}^{n}}{\partial {x}_{i}} {n}_{i} d Γ \qquad ( 36 )$$

As with equation (19) the surface Γ is the boundary that encapsulates the integration space Ω. The spatial derivate of the vector \vec{c}, δcᵢi/δxᵢ, is also a second-order spatial derivative of the level set function φ. If linear interpolation functions are used to describe the level set function than δcᵢ/δxᵢ can be omitted.

Equation (36) is a nonlinear hyperbolic equation. The level set function φ may be reinitialized so that |∇φ|=1, at least at points in the simulation space Ω near the interface S. In an embodiment of the present invention, it may only be necessary for the level set function to behave as an accurate distance function at points near the interface S. It may only be necessary to integrate equation (36) over τ=0 to t=aΔx, in which Δx=mesh size and a=0.8. In an embodiment of the present invention, the boundary integral of equation (36) is not significant and may be ignored.

Equation (37) is a simplified version of equation (36) in which a linear interpolation of the function is assumed, and the boundary integral over the boundary Γ is ignored.

$${\int }_{Ω}^{ } Ψ {Ψ}^{T} d Ω {Φ}^{m + 1} = Δ τ {\int }_{Ω}^{ } Ψ {s}_{0} ( 1 - \vert ∇ {φ}^{m} \vert ) d Ω + [ \begin{matrix}{\int }_{Ω}^{ } Ψ {Ψ}^{T} d Ω - \\ \frac{Δ {τ}^{2} }{2} {\int }_{Ω}^{ } \frac{\partial Ψ}{\partial {x}_{i}} \frac{\partial {Ψ}^{T}}{\partial {x}_{i}} d Ω\end{matrix} ] {Φ}^{m} \qquad ( 37 )$$

### Inclusion of Boundary Terms

Equations (20) and (36) include boundary integrals along the boundary Γ. As noted above an embodiment of the present invention may include ignoring the effect of the boundary Γ. An alterative embodiment of the present invention may include integrating along the boundary Γ, which would improve the accuracy of solutions found using the present invention.

Equations (38) and (39) are the boundary integrals in equations (20) and (36) that were ignored in embodiments of the present invention described above.

$$\begin{matrix}{\int }_{Γ}^{ } {\sum }_{i , j}^{ } Ψ {n}_{i} {u}_{i}^{n} {u}_{j}^{n} \frac{\partial {φ}^{n}}{\partial {x}_{j}} d Γ & ( 38 ) \\ {\int }_{Γ}^{ } {\sum }_{i}^{ } Ψ \frac{\partial {φ}^{n}}{\partial {x}_{i}} {n}_{i} d Γ & ( 39 )\end{matrix}$$

If the problem domain Ω is two dimensional than the integrals (38) and (39) are line integrals. While, if the problem domain Ω is three dimensional than the integrals (38) and (39) are boundary integrals. An individual skilled in the art would appreciate how to adapt a two dimensional solution to a three dimensional solution, without going beyond the scope and spirit of the present invention as described in the claims.

Since the nodal values of Ωⁿ at every time step is known to get φⁿ⁺¹, Eqn. (3.7) and (3.14); therefore, φⁿ in general can be found in terms of RK shape function, the derivatives can be easily obtained using the derivatives of the RK shape functions where NP is the number of discrete nodes.

$$\begin{matrix}{φ}^{h} = {\sum }_{I = 1}^{NP} {Ψ}_{I} ( {x}^{->} ) {φ}_{I} & ( 40 ) \\ \frac{\partial {φ}^{h}}{\partial {x}_{j}} = {\sum }_{I = 1}^{NP} \frac{\partial {Ψ}_{I} ( {x}^{->} )}{\partial {x}_{j}} {φ}_{I} \\ j = x , y , z & ( 41 ) \\ \frac{\partial {φ}^{h}}{\partial {x}_{j}} = {\sum }_{I = 1}^{NP} \frac{\partial {Ψ}_{I} ( {x}^{->} )}{\partial {x}_{j}} {φ}_{I} + {Ψ}_{I} \frac{\partial {φ}_{I} ( {x}^{->} )}{\partial {x}_{j}} \\ j = x , y , z & ( 41 )\end{matrix}$$

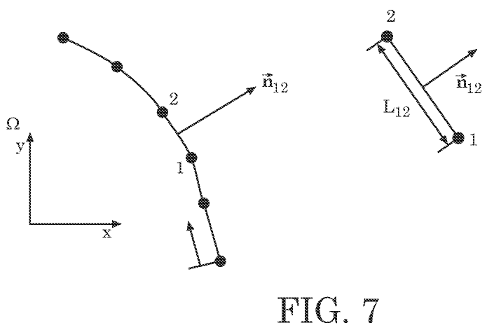

FIG. 7 is an illustration of a boundary. The vector \vec{n} is normal to the boundary as shown in FIG. 7. The boundary may be described using a series of nodes. The components of the vector \vec{n} may be described in terms of its components as stated in equation (42). These components may be calculated from the position of the nodes as described in equations (43)-(45).

$$\begin{matrix}{n}^{->} = {n}_{x , i} + {n}_{y , i} & ( 42 ) \\ {L}_{12} = \sqrt{{( {x}_{1} - {x}_{2} )}^{2} + {( {y}_{1} - {y}_{2} )}^{2}} & ( 43 ) \\ {n}_{x , 12} = ( {y}_{2} - {y}_{1} ) / {L}_{12} & ( 44 ) \\ {n}_{y , 12} = ( {x}_{1} - {x}_{2} ) / {L}_{12} & ( 45 )\end{matrix}$$

An embodiment of the present invention is distinguished from the prior art at least by making use of an integral along the boundary when reinitializing the boundary, as described in nonlinear equation (36). Prior art methods include the direct evaluation method that seeks out the zero level set Γ and recalculates the signed-distance function φ everywhere in the solution domain Ω. However, these prior art methods introduce considerable complication to the evolution and reinitialization procedures and require significant computational resources. The present invention lowers the resource requirements by making use of consistent integral equations. Computational resources are further reduced formulating the problem in terms of linear matrix equations. The present invention allows for these integral equations to be solved effectively and consistently using Reproducing Kernel shape functions.

Calculating the interface integrals (38) and (39) includes calculating the spatial derivative of the level set function. Calculating spatial derivatives of the level set function includes calculating spatial derivatives of the shape functions. When the shape function is a linear function the spatial derivate is a constant. An embodiment of the present invention may benefit from shape functions in which the spatial derivate of the shape function is not constant over the integration space. The shape function may take the form of a polynomial or some other non-linear function. In a preferred embodiment of the present invention, a second order shape function is used. As the dimension of the problem space increases, the advantage of a shape function that is not a first order approximation increases. The advantage of a higher order shape function also increases as the complexity of the interface increase.

### Numerical Results

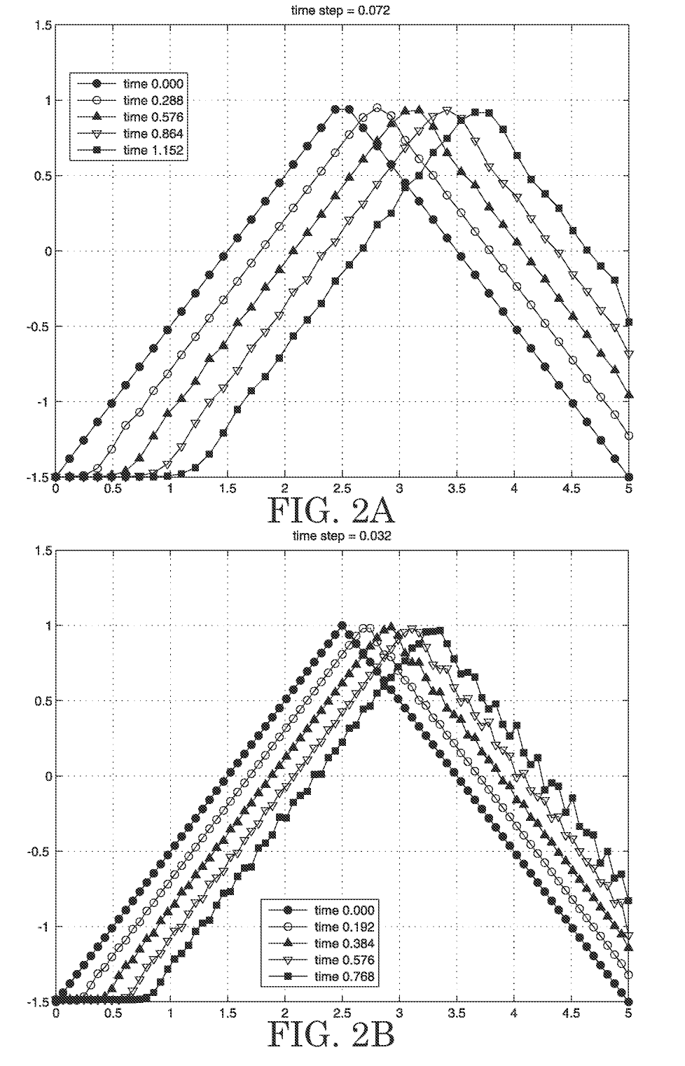

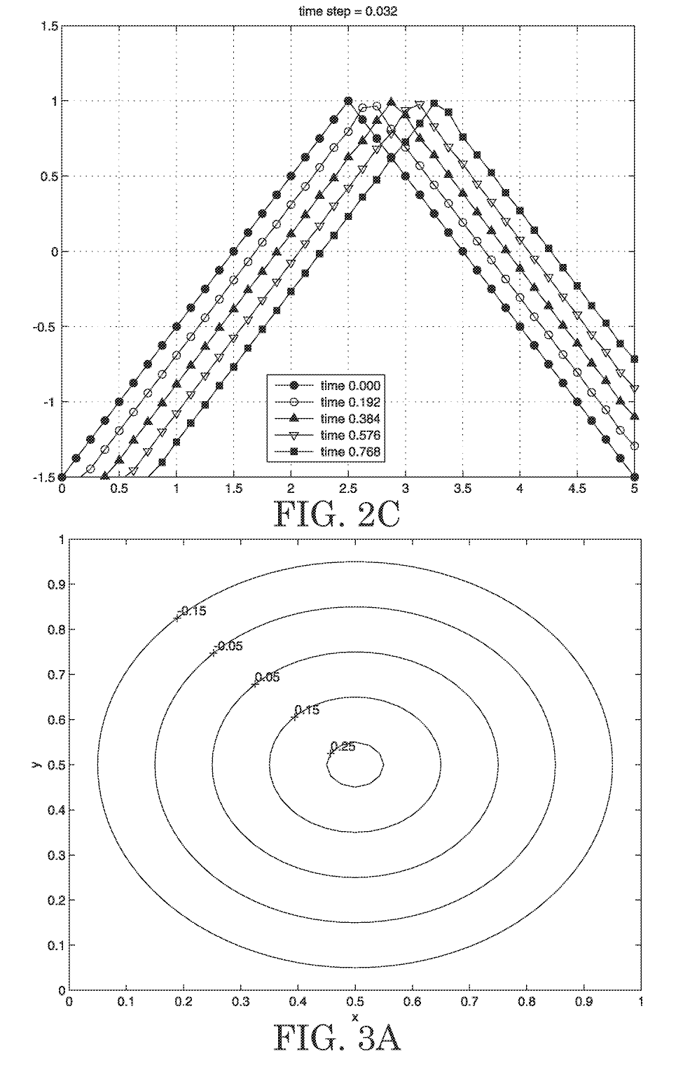

FIGS. 2A-2C show the evolution of a one-dimensional level set function over a series of time steps. FIG. 2A is an illustration of a one-dimensional level set function that is described using two-node linear finite elements. The time step in the evolution equation is 0.072 seconds. FIG. 2A show an initial level set function that at time t=0 is very smooth but after several latter time steps is no longer smooth. This is an artifact of the simulation and is not representative of the system be simulated.

FIG. 2B is an illustration of the evolution of a one-dimensional level set function like the one simulated in FIG. 2A. In FIG. 2B the level set function is described using three-node linear finite elements. The time step in this case is 0.032 seconds. As with the previous case, unstable solutions become clearly visible as time progresses.

FIG. 2C is an illustration of the evolution of a one-dimensional level set function in which the present invention was used to simulate the motion of the level set function. As FIG. 2C illustrates the results of the present invention are noticeably better results than the results using the finite element shown in FIGS. 2A-B.

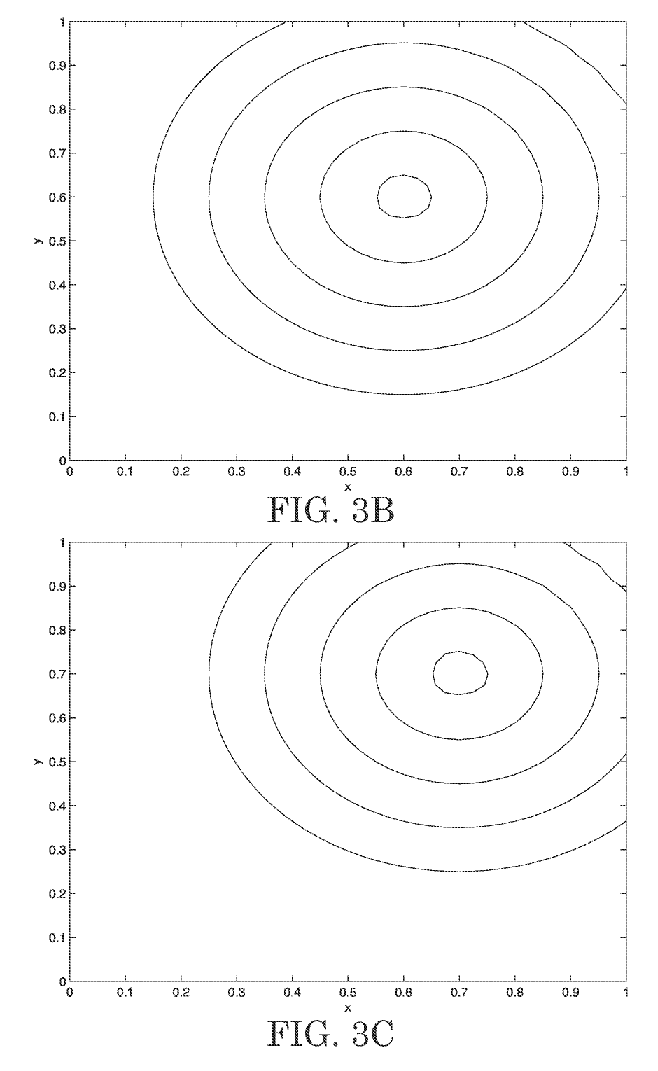

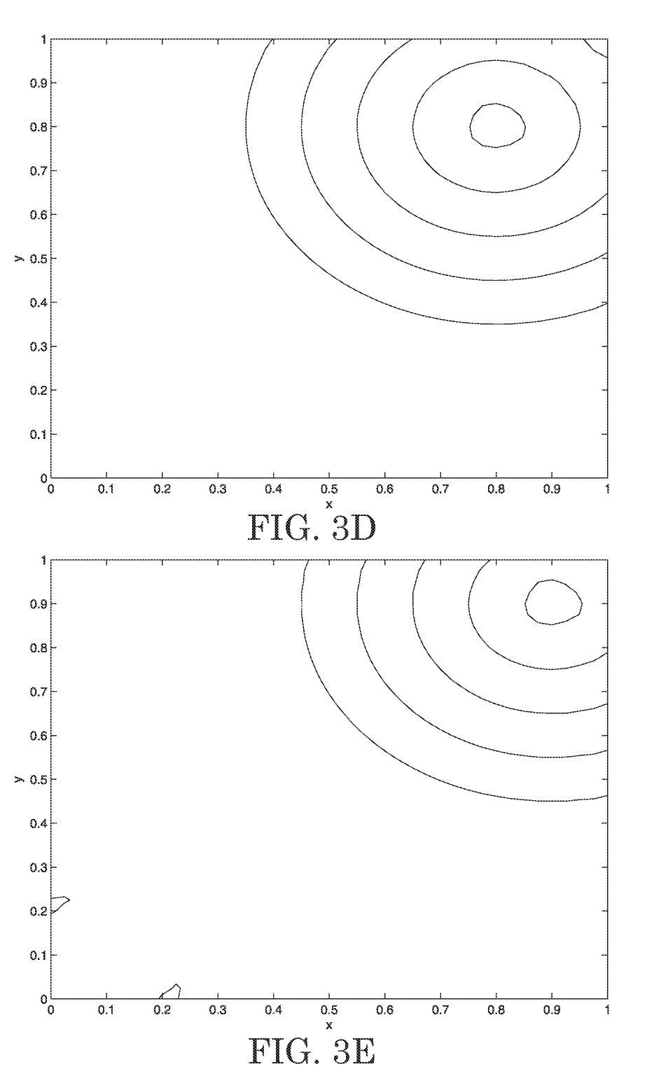

FIGS. 3A-3E are illustrations of the results of an embodiment of the present invention used to simulate the evolution of a two-dimensional level set function. In this simulation u₁=u₂=1.0 and Δt=0.01 and: FIG. 3A is at time t=0.0; FIG. 3B is at time t=0.02; FIG. 3C is at time t=0.04; FIG. 3D is at time t=0.06; and FIG. 3E is at time t=0.08;

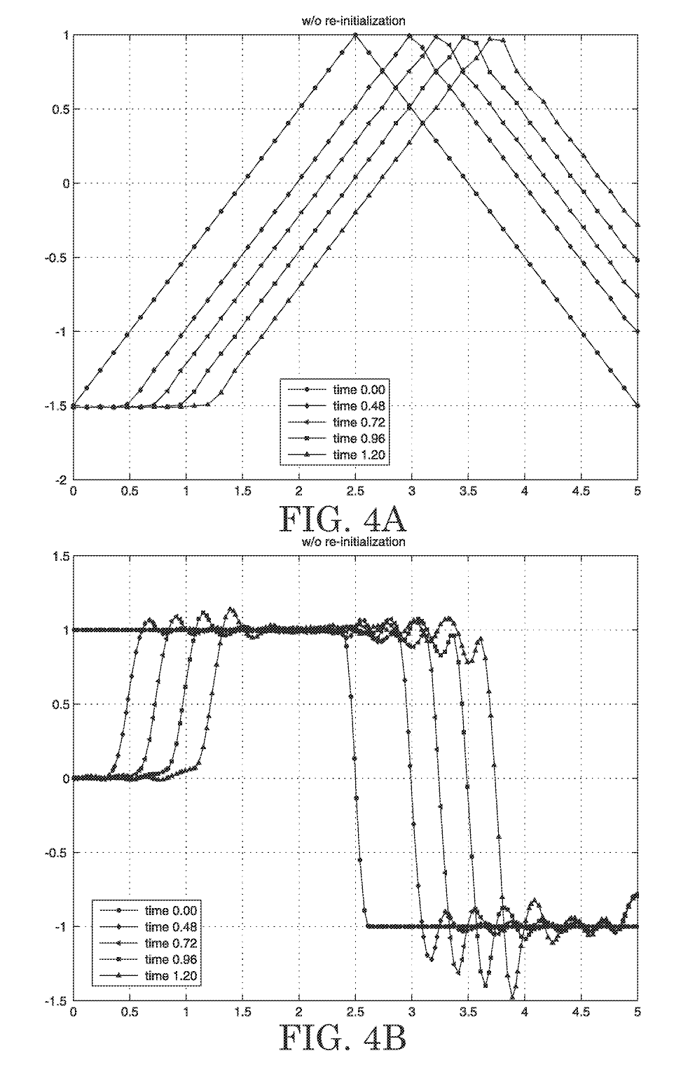

FIG. 4A is an illustration of the evolution of a one dimensional level set function φ at several different time steps as used in an embodiment of the present invention. FIG. 4B is an illustration of a spatial derivative of the level set function as shown in FIG. 4A. FIGS. 4A-B are illustrations of the evolution of one dimensional level set function in which the level set is not reinitialized and the boundary integral is ignored.

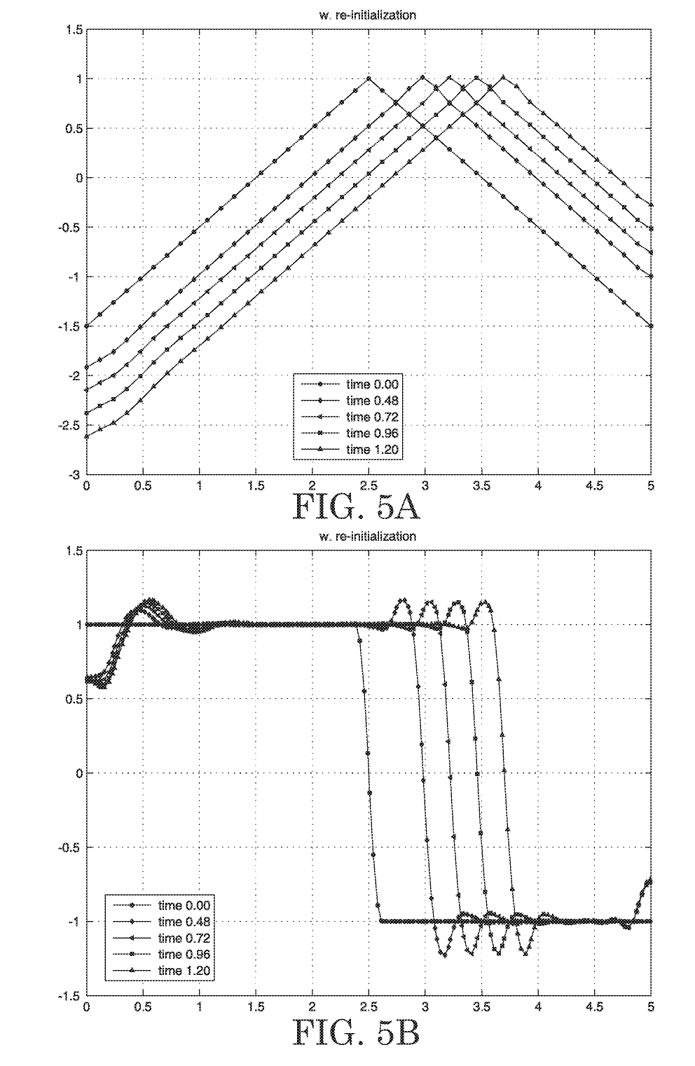

FIG. 5A is an illustration of the evolution of a one dimensional level set function φ at several different time steps in which the level set function is reinitialized as used in an embodiment of the present invention. FIG. 5B is an illustration of a spatial derivative of the level set function as shown in FIG. 5A. FIGS. 5A-B are illustrations of the evolution of one dimensional level set function in which the level set function is reinitialized and the boundary integral is ignored.

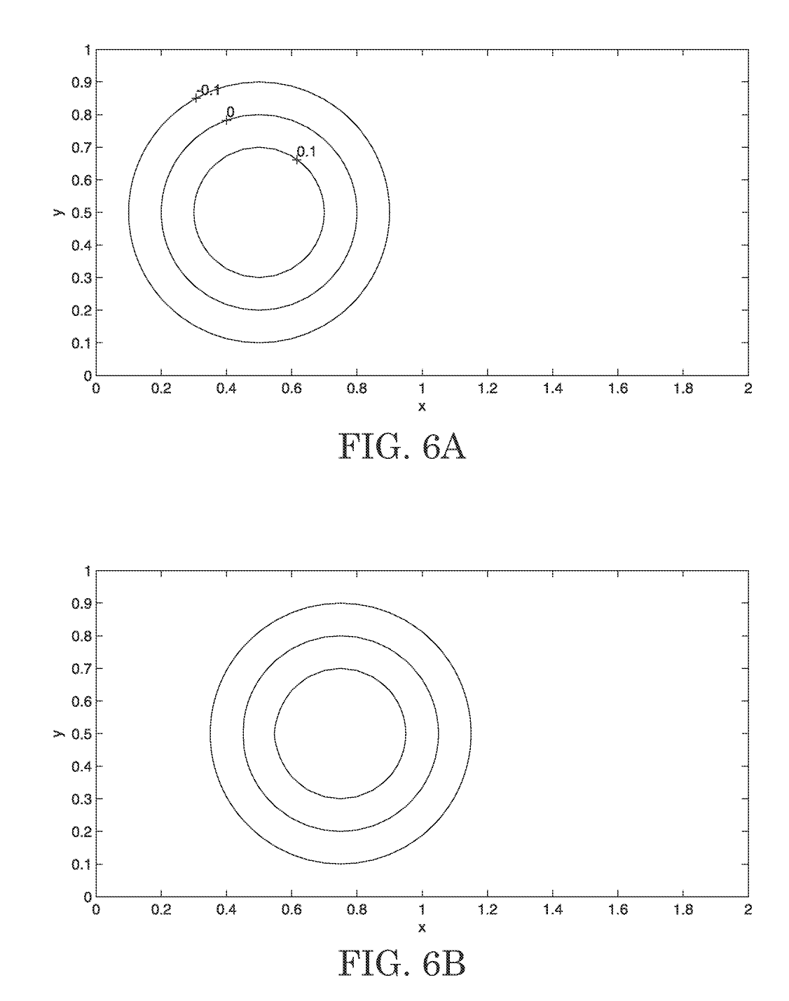

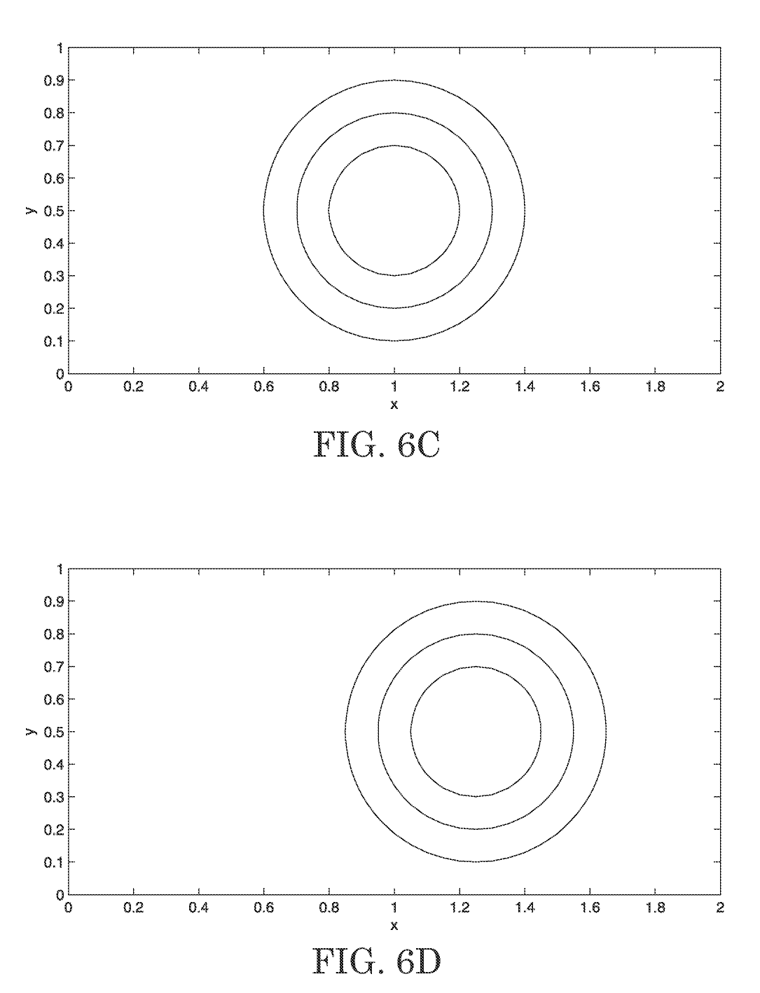

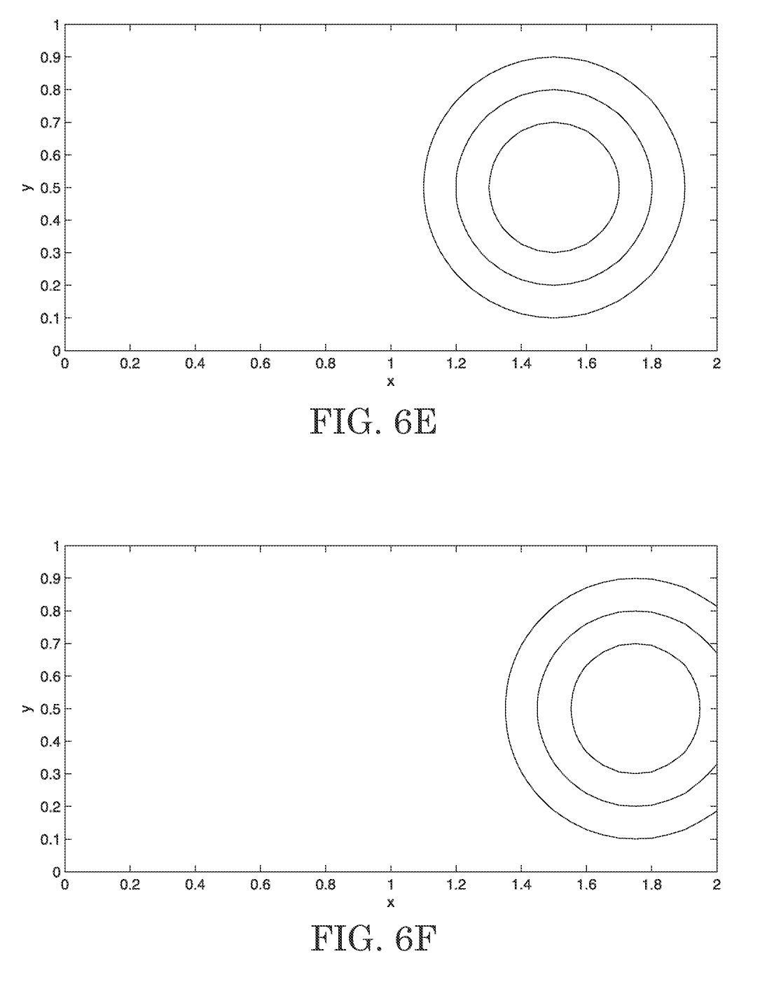

FIGS. 6A-F are illustrations of the evolution of a two dimensional level set function φ at several different time steps in which the level set function is reinitialized as used in an embodiment of the present invention. FIG. 6A is at time step t=0. FIG. 6B is at time step t=0.25. FIG. 6C is at time step t=0.50. FIG. 6D is at time step t=0.75. FIG. 6E is at time step t=1.00. FIG. 6F is at time step t=1.25.

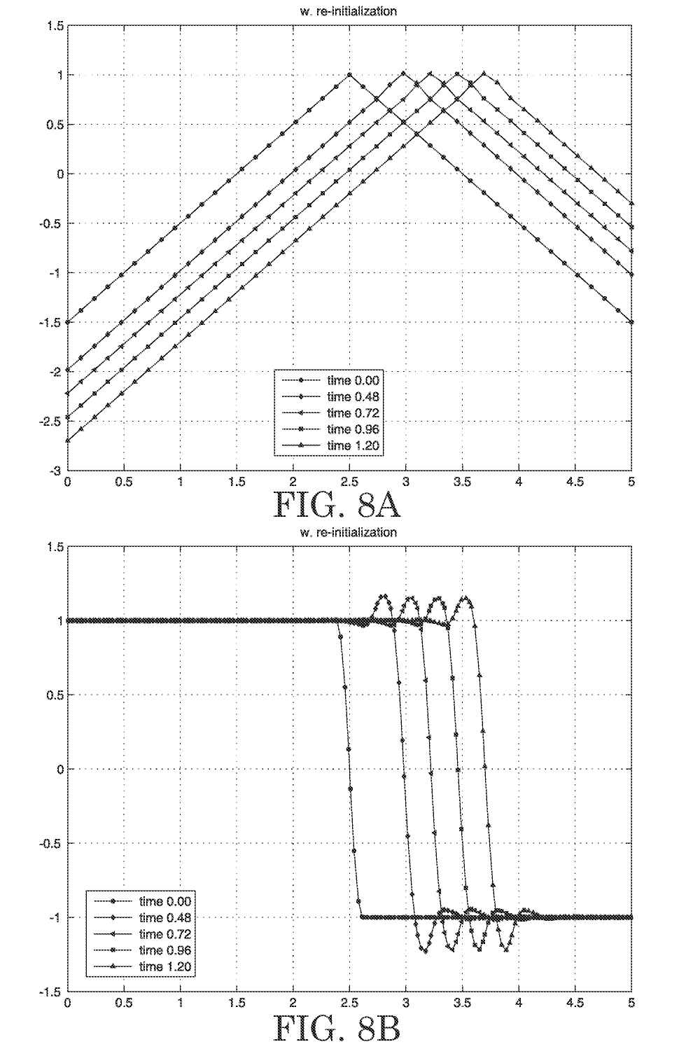

FIG. 8A is an illustration of the evolution of a one dimensional level set function φ at several different time steps in which the level set function is reinitialized and the boundary integral is not ignored as used in a preferred embodiment of the present invention. FIG. 8B is an illustration of a spatial derivative of the level set function as shown in FIG. 8A.

### Applications

An embodiment of the present invention may be used to describe an interface. The interface may be between a first material and a second material. The interface may be between a first fluid and a second fluid. The first fluid may be ink. The second fluid may be air. An embodiment of the present invention may also be used to describe the motion of the interface. The simulation of the motion of the interface may be used in a simulation of an ink jet print head. An embodiment of the present invention may be used in the process of designing an ink jet head. An embodiment of the present invention may be used in the process of designing an object in which the motion of the interface is a matter of interest. An embodiment of the present invention may be an object that was designed using the method described above as a guide. An individual skilled in the art would appreciate that the present invention may be used to design other products.

### System

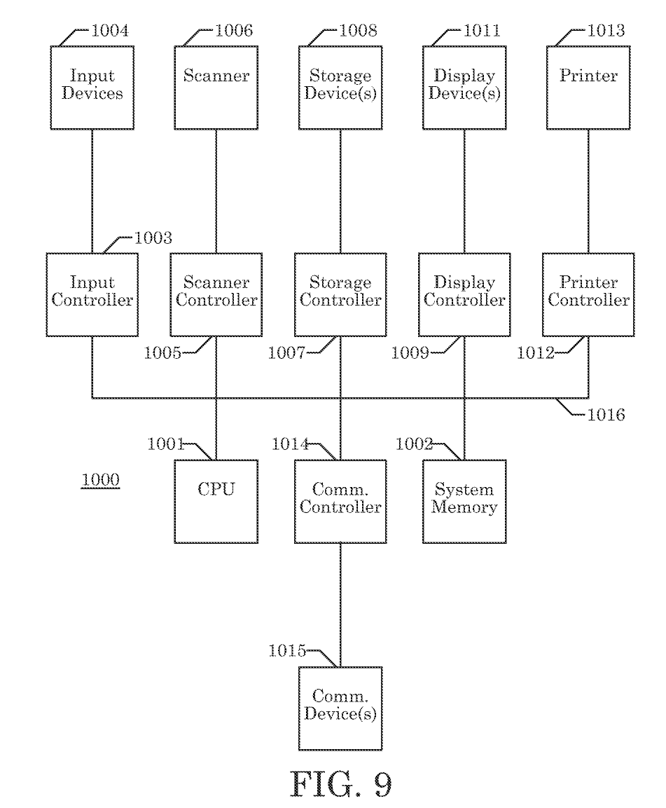

Having described the details of the invention, an exemplary system 1000, which may be used to implement one or more aspects of the present invention will now be described with reference to FIG. 9. As illustrated in FIG. 9, the system includes a central processing unit (CPU) 1001 that provides computing resources and controls the computer. The CPU 1001 may be implemented with a microprocessor or the like, and may also include a graphics processor and/or a floating point coprocessor for mathematical computations. The system 1000 may also include system memory 1002, which may be in the form of random-access memory (RAM) and read-only memory (ROM).

A number of controllers and peripheral devices may also be provided, as shown in FIG. 9. An input controller 1003 represents an interface to various input device(s) 1004, such as a keyboard, mouse, or stylus. There may also be a scanner controller 1005, which communicates with a scanner 1006. The system 1000 may also include a storage controller 1007 for interfacing with one or more storage devices 1008 each of which includes a storage medium such as magnetic tape or disk, or an optical medium that might be used to record programs of instructions for operating systems, utilities and applications which may include embodiments of programs that implement various aspects of the present invention. Storage device(s) 1008 may also be used to store processed data or data to be processed in accordance with the invention. The system 1000 may also include a display controller 1009 for providing an interface to a display device 1011, which may be a cathode ray tube (CRT), or a thin film transistor (TFT) display. The system 1000 may also include a printer controller 1012 for communicating with a printer 1013. A communications controller 1014 may interface with one or more communication devices 1015 which enables the system 1000 to connect to remote devices through any of a variety of networks including the Internet, a local area network (LAN), a wide area network (WAN), or through any suitable electromagnetic carrier signals including infrared signals.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including magnetic tape or disk or optical disc, or a transmitter, receiver pair.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. Accordingly, the “means” terms in the claims are intended to cover both software and hardware implementations. Similarly, the term “computer-readable medium” as used herein includes software and or hardware having a program of instructions embodied thereon, or a combination thereof. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution on a computer readable medium. Alternatively, any of the methods or steps thereof may be implemented using functionally equivalent hardware (e.g., application specific integrated circuit (ASIC), digital signal processing circuitry, etc.) or a combination of software and hardware.

While the invention has been described in conjunction with several specific embodiments, it is evident to those skilled in the art that many further alternatives, modifications, and variations will be apparent in light of the foregoing description. Thus, the invention described herein is intended to embrace all such alternatives, modifications, applications and variations as may fall within the spirit and scope of the appended claims.

What is claimed is:

1. A method for simulating the motion of an interface moving through a simulation space comprising:
simulating the interface using a level set function to describe a position and shape of the interface in the simulation space at a first point in time describing the level set function at the first point time using a meshfree method;
describing a motion of the interface from the first point in time to a second point time using a level set evolution method; and
finding an approximate solution to the level set evolution method using the meshfree method to describe the level set function at the second point in time.

2. The method of claim 1, wherein the meshfree method is a Reproducing Kernel Particle Method.

3. The method of claim 1, wherein the interface is between a first fluid and a second fluid.

4. The method of claim 3, wherein the first fluid is ink, and the second fluid is air.

5. A computer-readable medium encoded with instructions to a computer for performing the method of claim 1.

6. A system including a memory module and instructions for performing the method of claim 1.

7. The method of claim 1, wherein the meshfree method approximates the level set function using a first family of functions that define the smoothness of the approximation of the level set function, and each function in the first family of functions has a compact support, and the size of the compact support is a function of a maximum of a set of k-th ordered statistics of a plurality of distances between sets of distinct nodes in the simulation space.

8. The method of claim 7, wherein k is selected from the group consisting of 2, 3, 4, and 5.

9. The method of claim 7, wherein the size of the compact support is also a function of an order of an enrichment function.

10. The method of claim 1, wherein the level set evolution method is in described in terms of spatial derivates of the level set function; the spatial derivatives of the level set function are discretized, and a mesh free method is used to describe each of the discretized terms of the spatial derivatives of the level set function.

11. The method of claim 10, wherein the level set evolution method includes an integral along a boundary surrounding the simulation space, including a spatial derivate of the level set function, a test function, and components of a vector normal to the boundary.

12. The method of claim 1, further comprising the designing a physical object based on the results of the method of simulating the motion of an interface.

13. The method of claim 12, wherein the physical object is an ink jet head.

14. The method of claim 7 wherein each function in the family of function is positive in the area bounded by the size of the compact support.

15. The method of claim 1, wherein the meshfree method approximates the level set function using a first family of functions that define the smoothness of the approximation of the level set function, and each function in the first family of functions has a compact support, and the size of the compact support is a function of a maximum of a set of k-th ordered statistics of a plurality of power sums of differences between components that define the positions of sets of distinct nodes in the simulation space.

16. The physical object designed using the method of claim 12.

17. The physical object of claim 16, wherein the physical object is an ink jet head.
